(19) United States
(12) Patent Application Publication
(10) Pub. No.: US 2024/0365384 A1
(43) Pub. Date: Oct. 31, 2024

(54) CHANNEL UTILIZATION FOR LATENCY SENSITIVE TRAFFIC TRANSMISSION

(71) Applicant: Senscomm Semiconductor Co., Ltd., Suzhou (CN)

(72) Inventors: Sung Jin PARK, Seoul (KR); DAEHONG KIM, Laguna Hills, CA (US)

(21) Appl. No.: 18/645,305

(22) Filed: Apr. 24, 2024

Related U.S. Application Data
(60) Provisional application No. 63/498,774, filed on Apr. 27, 2023.
(60) Provisional application No. 63/562,410, filed on Mar. 7, 2024.

(30) Foreign Application Priority Data
Apr. 19, 2024 (CN) 202410478592.1

(51) Int. Cl. H04W 74/0816; H04W 8/22; H04W 74/08

(52) U.S. Cl. CPC H04W 74/0816; H04W 8/22; H04W 74/0866

(57) ABSTRACT

A station device (STA) for connecting to a wireless network, that includes processing circuitry configured to cause transmit capabilities regarding performing clear channel assessment (CCA) on one or more secondary channels of a basic service set (BSS) to an access point (AP) device, receive channel information identifying a secondary channel that is used for latency sensitive data from the AP device, detect an occurrence of latency sensitive data to be transmitted to a different device, perform CCA on the primary channel and detect that the primary channel is busy, perform the CCA on the secondary channel used for latency sensitive data and detect that the secondary channel is idle, transmit the latency sensitive data on the secondary channel.

### CROSS REFERENCE TO RELATED APPLICATION

This application claims benefit of U.S. Provisional Application No. 63/498,774, filed on Apr. 27, 2023, and U.S. Provisional Application No. 63/562,410, filed on Mar. 7, 2024, in the United States Patent and Trademark Office, and China Patent Application No. 202410478592.1, filed on Apr. 19, 2024, in the China National Intellectual Property Administration, the entire contents of which are hereby incorporated by reference.

### TECHNICAL FIELD

The disclosure relates generally to wireless communication, and more particularly to, for example, but not limited to, channel utilization for latency sensitive traffic.

### BACKGROUND

Wireless local area network (WLAN) devices are widely deployed in diverse environments to provide various communication services such as video, cloud access, broadcasting and offloading. Some of these environments have a lot of access points (AP) stations and non-AP stations in geographically limited areas. The WLAN technology has evolved toward increasing data rates and continues its growth in various markets such as home, enterprise and hotspots over the years since the late 1990s. Recently released standard (IEEE 802.11ax-2021) provides improved network performance in the high-density scenario by adopting OFDMA and MU-MIMO technologies. These improvements can be used to support environments such as outdoor hotspots, dense residential/office area, and stadiums.

However, there is a general need for improved WLAN to support real-time applications or delay-sensitive applications that require strict requirements on the delay and packet loss ratio. These applications include online gaming, real-time video streaming, virtual reality, and remote-control drones and vehicles.

The description set forth in the background section should not be assumed to be prior art merely because it is set forth in the background section. The background section may describe aspects or embodiments of the present disclosure.

### SUMMARY

One aspect of the present disclosure provides a station device for connecting to a wireless network, comprising processing circuitry configured to transmit capabilities information regarding an ability to perform clear channel assessment (CCA) on one or more secondary channels of a basic service set (BSS) to an access point (AP) device. The processing circuitry is configured to receive channel information identifying a primary channel and a secondary channel that is used for latency sensitive data from the AP device. The processing circuitry is configured to detect an occurrence of latency sensitive data to be transmitted to a first device. The processing circuitry is configured to perform CCA on the primary channel and detect that the primary channel is busy. The processing circuitry is configured to perform CCA on the secondary channel that is used for latency sensitive data and detect that the secondary channel is idle. The processing circuitry is configured to transmit the latency sensitive data on the secondary channel to the first device.

In some embodiments, the processing circuitry is configured to transmit or receive data on the primary channel with the first device.

In some embodiments, the processing circuitry is configured to transmit or receive data on the primary channel with a second device that is different from the first device.

In some embodiments, the station device is a transmission opportunity (TXOP) holder or a TXOP responder.

In some embodiments, the latency sensitive data is transmitted to the first device during a TXOP duration of the station device.

In some embodiments, the first device is the AP device.

In some embodiments, the secondary channel that is used for latency sensitive data has a center frequency that is farthest from a center frequency of the primary channel among a plurality of secondary channels in a basic service set (BSS).

In some embodiments, the processing circuitry is configured to receive information explicitly identifying the secondary channel that is used for latency sensitive data.

In some embodiments, the processing circuitry is further configured to perform CCA on a plurality of secondary channels and transmit latency sensitive data through an idle channel among the plurality of secondary channels.

One aspect of the present disclosure provides a station device for connecting to a wireless network, comprising processing circuitry configured to transmit capabilities information regarding an ability to perform clear channel assessment (CCA) on one or more secondary channels of a basic service set (BSS) to an access point (AP) device. The processing circuitry is configured to receive channel information identifying a primary channel and a secondary channel that is used for latency sensitive data from the AP device. The processing circuitry is configured to transmit or receive data on the primary channel with a first device. The processing circuitry is configured to receive latency sensitive data on the secondary channel that is used for latency sensitive data from a second device.

In some embodiments, the station device is a transmission opportunity (TXOP) holder or a TXOP responder.

In some embodiments, the first device is same as the second device.

In some embodiments, the secondary channel used for latency sensitive data has a center frequency that is farthest from a center frequency of the primary channel among a plurality of secondary channels in a basic service set (BSS).

In some embodiments, the processing circuitry is configured to receive information explicitly identifying the secondary channel that is used for latency sensitive data.

In some embodiments, the processing circuitry is configured to perform CCA on a plurality of secondary channels and transmit latency sensitive data through an idle channel among the plurality of secondary channels.

On aspect of the present disclosure provides an access point (AP) device for facilitating wireless communication in a wireless network. The AP device comprising processing circuitry configured to receive capabilities information regarding an ability to perform clear channel assessment (CCA) on one or more secondary channels of a basic service set (BSS) from a first station (STA) device. The processing circuitry is configured to generate channel information for the first STA device identifying a primary channel and a secondary channel that is used for latency sensitive data. The processing circuitry is configured to provide the channel information to the first STA device.

In some embodiments, the secondary channel used for latency sensitive data has a center frequency that is farthest from a center frequency of the primary channel among a plurality of channels in a basic service set (BSS).

In some embodiments, the processing circuitry is further configured to receive capabilities information regarding an ability to perform clear channel assessment (CCA) on one or more secondary channels of a basic service set (BSS) from a second STA device. The processing circuitry is configured to generate channel information for the second STA identifying a primary channel and a secondary channel that is used for latency sensitive data. The processing circuitry is configured to provide the channel information to the second STA device, wherein the secondary channel that is used for latency sensitive data for the second STA device is different from the secondary channel that is used for latency sensitive data for the first STA device.

In some embodiments, the processing circuitry is configured to set the secondary channel that is farthest from the primary channel as the secondary channel that is used to for latency sensitive data for the first STA.

In some embodiments, the processing circuitry is configured to transmit information explicitly identifying the secondary channel that is used for latency sensitive data to the first STA device.

### BRIEF DESCRIPTION OF THE DRAWINGS

FIG. 1 illustrates an example of a wireless communication network in accordance with an embodiment.

FIG. 2 illustrates an example of a timing diagram of interframe space (IFS) relationships between wireless devices in accordance with an embodiment.

FIG. 3 illustrates examples of OFDM symbols and OFDMA symbols in accordance with an embodiment.

FIG. 4A illustrates an example of PPDU format in accordance with an embodiment. The PPDU may be used for SU and MU transmission.

FIG. 4B illustrates another example of PPDU format in accordance with an embodiment.

FIG. 5 illustrates a schematic diagram of an example of an electronic device in accordance with an embodiment.

FIG. 6 illustrates a schematic diagram of an example of a transmitter in accordance with an embodiment.

FIG. 7 illustrates a schematic diagram of an example of a receiver in accordance with an embodiment.

FIG. 8 illustrates an example of several STAs informing an AP regarding their capabilities to perform CCA in accordance with an embodiment of the invention.

FIG. 9 illustrates an example of an AP providing STAs with information regarding a channel for latency sensitive traffic transmission in accordance with an embodiment of the invention.

FIG. 10A illustrates an example of a latency sensitive traffic channel element included in an association response frame in accordance with an embodiment of the invention.

FIG. 10B illustrates an example of an LST channel field in an LST channel element in accordance with an embodiment of the invention.

FIGS. 11A-11D illustrate an example of channel bonding and setting a channel for latency sensitive traffic transmission for a BSS operating channel in accordance with an embodiment of the invention.

FIGS. 12A-12H illustrate an example of channel bonding and setting of the latency sensitive traffic channel for a BSS operating channel in accordance with an embodiment of the invention.

FIG. 13 illustrates an example of a TXOP holder transmitting latency sensitive traffic on a latency sensitive traffic channel to a TXOP responder in accordance with an embodiment of the invention.

FIG. 14 illustrates an example of transmitting latency sensitive traffic to a device that is neither a TXOP holder nor a TXOP responder in accordance with an embodiment of the invention.

FIG. 15 illustrates an example of transmitting latency sensitive traffic from a TXOP responder to a TXOP holder in accordance with an embodiment of the invention.

FIG. 16 illustrates an example of a TXOP holder transmitting data to a TXOP responder and the TXOP responder transmitting latency sensitive traffic data in accordance with an embodiment of the invention.

FIG. 17 illustrates an example of transmitting latency sensitive traffic data from a device that is neither a TXOP holder nor a TXOP responder in accordance with an embodiment of the invention.

FIG. 18 illustrates a flow chart of an example of determining a latency sensitive traffic channel between an AP and one or more STAs in accordance with an embodiment.

FIG. 19 illustrates a flow chart of an example of transmitting latency sensitive traffic between devices in accordance with an embodiment.

### DETAILED DESCRIPTION

The detailed description provided below is intended to describe various implementations and is not intended to represent the sole implementation. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The detailed description below has been described with reference to a WLAN system based on the Institute of Electrical and Electronics Engineers (IEEE) 802.11 wireless standards, including the current and future amendments. However, a person having ordinary skill in the art will readily recognize that the teachings herein are applicable to other network environments, such as cellular telecommunication networks and wired telecommunication networks.

In some embodiments, apparatuses or devices such as an AP station and a non-AP station may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. Additionally, the apparatus may include one or more other hardware or software elements such as a network interface and a display device.

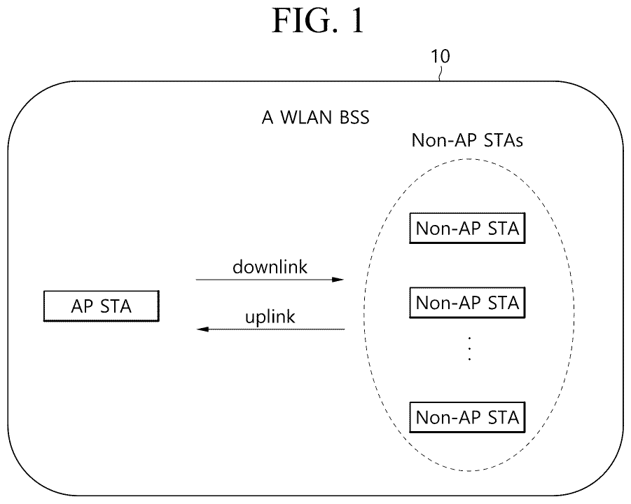

FIG. 1 illustrates an example of a wireless communication network in accordance with an embodiment. The wireless communication network may include a Basic Service Set (BSS) 10. The BSS 10 provides the basic organizational unit and includes a plurality of wireless devices which may be referred to as stations (STAs). In some implementations, the wireless device may include a plurality of STAs inside. The STA maybe a logical entity that is a singly addressable instance of a medium access control (MAC) and physical layer (PHY) interface to the wireless medium (WM) according to IEEE 802.11 standards. The STA may be an access point (AP) STA and a non-AP STA. The AP STA may be an entity that contains one STA and provides access to the distribution system services via the wireless medium for associated STAs. The non-AP STA may be a STA that is not contained within an AP STA. The AP STA and the non-AP STA may be collectively called an STA. For simplicity of description, an AP STA may be referred to as an AP and a non-AP STA may be referred to as a STA or a station. The AP STA may comprise, be implemented as, or be included in a wireless device such as a centralized controller, a base station (BS), a node-B, a base transceiver system (BTS), a site controller, a network adapter, and a router. Similarly, the non-AP STA may comprise, be implemented as, or be included in a wireless communication device such as a terminal, a wireless transmit/receive unit (WTRU), a user equipment (UE), a mobile station (MS), a mobile terminal, a mobile subscriber unit, a laptop, a smartphone, a battery pack, and a non-mobile computing device.

Referring to FIG. 1, the BSS 10 in the wireless communication network may include an AP STA 11 and a plurality of non-AP STAs 12. The AP STA 11 may transmit information to a single station among the non-AP STAs 12 or may simultaneously transmit information to two or more stations among the non-AP STAs 12. The AP STA 11 may use, for the simultaneous transmission, Downlink (DL) multi-user (MU) transmission scheme such as DL OFDMA (Orthogonal Frequency Division Multiplexing Access) and DL MU-MIMO (Multi-User Multi-Input-Multi-Output). Similarly, each of the non-AP STAs 12 may individually transmit information to an AP STA or may simultaneously transmit information along with one or more other non-AP STAs 12. The non-AP STAs 12 may use, for the simultaneous transmission, Uplink (UL) MU transmission scheme such as UL OFDMA and UL MU-MIMO. In MU-MIMO transmission, a transmitting station may simultaneously transmit information to a plurality of receiving stations using one or more antennas over the same subcarriers. Different spatial streams may be used as the different resources in the MU-MIMO transmission. In OFDMA transmission, a transmitting station may simultaneously transmit information to a plurality of receiving stations over different groups of subcarriers. Different frequency (subcarriers) may be used as the different resource in the OFDMA transmission.

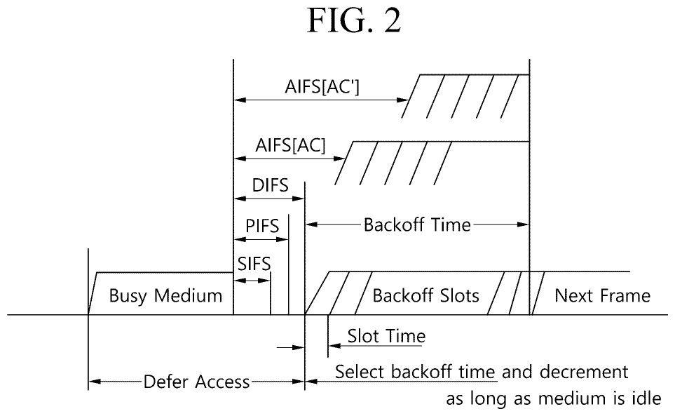

FIG. 2 illustrates an example of a timing diagram of interframe space (IFS) relationships between wireless devices in accordance with an embodiment. FIG. 2 depicts a CSMA (carrier sense multiple access)/CA (collision avoidance) frame transmission procedure to prevent collision between frames on a channel. These frames may include a data frame, a control frame, or a management frame that are exchanged among wireless devices.

The data frame may be used for transmission of data forwarded to a higher layer in a receiving station. In FIG. 2, access to the medium by wireless devices is deferred while the medium is busy until an IFS duration has elapsed. For example, a wireless device may transmit a data frame after completing a backoff period when a Distributed Coordination Function (DCF) IFS (DIFS) has expired. The management frame may be used for exchanging management information which is not forwarded to the higher layer in a receiving station. The management frame includes a beacon frame, an association request/response frame, disassociation frame, reassociation request/response frame, a probe request/response frame, and an authentication request/response frame and action frame. The control frame may be used for controlling access to the medium. The control frame includes a request to send (RTS) frame, a clear to send (CTS) frame, and an acknowledgment (ACK) frame, BlockAck request/response frame, NDP (Null Data PPDU) Announcement frame. If the control frame is not a response frame to another frame, the wireless device may transmit the control frame after performing backoff operation when the DIFS has elapsed. However, if the control frame is a response frame to another frame, the wireless device may transmit the control frame without performing backoff operation when a short IFS (SIFS) has elapsed. Furthermore, a QoS (Quality of Service) STA may transmit a frame after performing backoff operation when an arbitration IFS (AIFS) for access category (AC) (i.e., AIFS [AC]) has elapsed. In some embodiments, a point coordination function (PCF) enabled AP STA may transmit the frame after performing backoff operation when a PCF IFS (PIFS) has elapsed. The PIFS duration may be less than the DIFS duration, but greater than the SIFS duration.

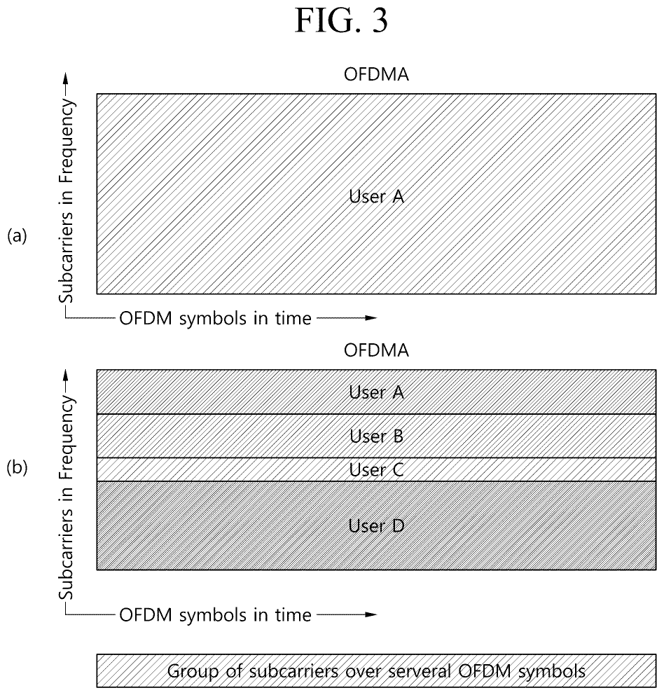

FIG. 3 illustrates examples of OFDM symbols and OFDMA symbols in accordance with an embodiment. In FIGS. 3(a) and 3(b), OFDM/OFDMA symbols are illustrated along the time dimension and subcarriers are illustrated along the frequency dimension.

The OFDMA was introduced in IEEE 802.11ax standard which is also known as High Efficiency (HE) WLAN. The OFDMA will be also used in next amendments to IEEE 802.11 standard such as Extreme High Throughput (EHT) WLAN. One or more STAs may be allowed to use one or more resource units (RUs) throughout operating bandwidth to transmit data at the same time. The RU may be a group of subcarriers as an allocation for subcarriers for transmission. In some aspects, non-AP STAs may be associated or non-associated with AP STA when transmitting response frames simultaneously in assigned RUs after a specific period of time such as SIFS. The SIFS may be the time from the end of the last symbol, or signal extension if present, of the previous frame to the beginning of the first symbol of the preamble of the subsequent frame.

The OFDMA is an OFDM-based multiple access scheme where different groups of subcarriers are allocated to different users, which allows simultaneous transmission to one or more users with high accurate synchronization for frequency orthogonality. The OFDMA allows users to be allocated to different groups of subcarriers in each PPDU (physical layer protocol data unit). An OFDM symbol in the OFDMA may include a plurality of subcarriers depending on the bandwidth of the PPDU. The difference between OFDM and OFDMA is illustrated in FIG. 3. As shown in FIG. 3(a), the OFDM symbol includes one single user (User A), while the OFDMA symbol includes a plurality of users (User A, User B, User C, and User D) and each user is assigned and allocated into different group of subcarriers as shown in FIG. 3(b).

In the case of UL MU transmission, the AP STA may control the medium by using more scheduled access mechanism which allows AP STAs and non-AP STAs to use OFDMA and MU-MIMO. A UL MU PPDU may be sent by non-AP STAs as a response to a trigger frame sent by the AP STA. The trigger frame may have information for receiving STAs and assign a single or multiple RU to the receiving STAs. It allows non-AP STAs to transmit OFDMA-based frame in the form of trigger-based (TB) PPDU (e.g., HE TB PPDU or EHT TB PPDU) where an operating bandwidth is segmented into a plurality of RUs and each RU serves as responses to the trigger frame. For simplicity of description, a single RU and a multiple RU (MRU) which are allocated into a non-AP STA may be collectively referred to as an RU. In some embodiments, the MRU may indicate the combination of two RUs.

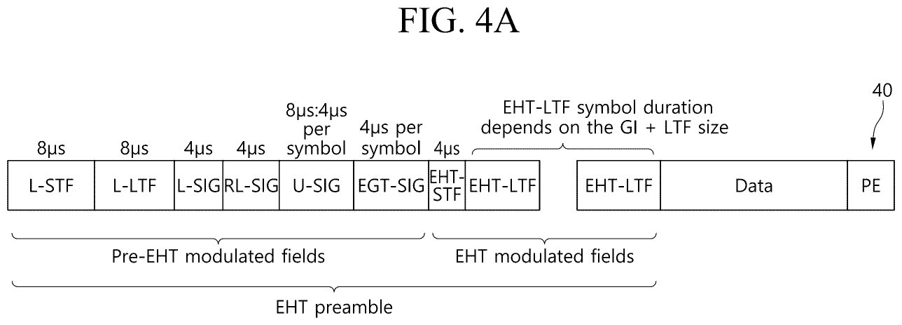

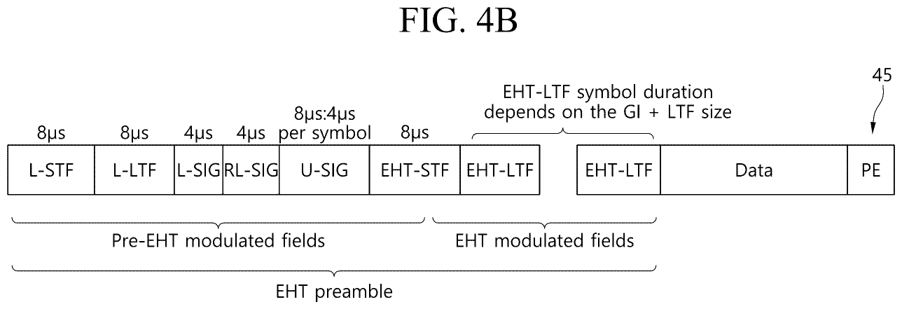

FIG. 4A illustrates an example of PPDU format in accordance with an embodiment. The PPDU may be used for SU and MU transmission. The PPDU may be used as EHT MU PPDU in accordance with IEEE 802.11be or may be used as a PPDU in accordance with any future amendments to the IEEE 802.11 standard.

Referring to FIG. 4A, the EHT MU PPDU 40 may include an EHT preamble (may be referred to as a preamble or PHY preamble), a data field, and a packet extension (PE) field. The EHT preamble may include pre-EHT modulated fields and EHT modulated fields. The pre-EHT modulated fields may include a legacy short training field (L-STF), a legacy long training field (L-LTF), a legacy signal (L-SIG) field, a repeated legacy signal (RL-SIG) field, a universal signal (U-SIG) field and a EHT signal (EHT-SIG) field. The EHT modulated fields may include an EHT short training field (EHT-STF) and one or more EHT long training fields (EHT-LTFs).

The L-STF may be utilized for packet detection, automatic gain control (AGC) and coarse frequency-offset correction. The L-LTF may be utilized for channel estimation, fine frequency-offset correction, and symbol timing. The L-SIG field may provide information for communication such as data rate, a length related to the EHT PPDU 40. The RL-SIG field may be a repeat of the L-SIG field and may be used to differentiate an EHT PPDU from other PPDUs conforming to other IEEE 802.11 standards such as IEEE 802.11a/n/ac. The U-SIG field may provide information necessary for receiving STAs to interpret the EHT MU PPDU. The EHT-SIG may provide additional information to the U-SIG field for receiving STAs to interpret the EHT MU PPDU 40. For simplicity of description, the U-SIG field, the EHT-SIG field or both may be referred to herein as the SIG field. EHT-LTFs may enable receiving STAs to estimate the MIMO channel between a set of constellation mapper output and the receive chains. The data field may carry one or more PHY service data units (PSDUs). The PE field may provide additional receive processing time at the end of the EHT MU PPDU.

FIG. 4B illustrates another example of PPDU format in accordance with an embodiment. The PPDU in FIG. 4B may be used for SU and MU transmission. The PPDU 45 may be used as EHT TB (Trigger-based) PPDU in accordance with IEEE 802.11be or may be used as a PPDU conforming to any of future amendments to the IEEE 802.11 standard. In some embodiments, the EHT TB PPDU 45 is used for transmission by non-AP STA that is a response to a triggering frame from an AP STA.

As shown in FIG. 4B, the EHT TB PPDU 45 may include an EHT preamble (may be referred to as a preamble or PHY preamble), a data field, and a packet extension (PE) field. The EHT preamble may include pre-EHT modulated fields and EHT modulated fields. The pre-EHT modulated fields may include a L-STF field, a L-LTF field, a L-SIG field, a RL-SIG field, a U-SIG field. The EHT modulated fields may include an EHT-STF and one or more EHT-LTFs. Unlike the EHT MU PPDU 40, the EHT-SIG may not be present in the EHT TB PPDU 45. Instead, the duration (8 us) of the EHT-STF of the EHT TB PPDU 45 may be twice the duration (4 us) of the EHT-STF of the EHT MU PPDU 40. Detailed description for the other fields in the EHT TB PPDU 45 will be omitted since the description for each field in the EHT MU PPDU 40 can be applied to each corresponding field of the EHT TB PPDU 45.

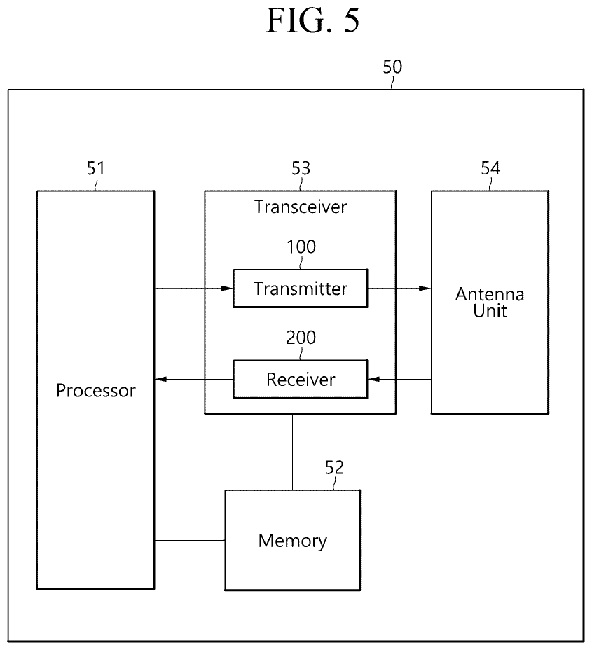

FIG. 5 illustrates a schematic diagram of an example of an electronic device in accordance with an embodiment. The electronic device 50 may be an example of the AP STA 11 or non-AP STA 12 shown in FIG. 1.

Referring to FIG. 5, the electronic device 50 may include a processor 51, a memory 52, a transceiver 53, and an antenna unit 54. The transceiver 53 may include a transmitter 100 and a receiver 200.

The processor 51 may perform medium access control (MAC) functions, PHY functions, RF functions, or a combination of some or all of the foregoing. In some embodiments, the processor 51 may comprise some or all of a transmitter 100 and a receiver 200. The processor 51 may be directly or indirectly coupled to the memory 52. In some embodiments, the processor 51 may include one or more processors.

The memory 52 may be non-transitory computer-readable recording medium storing instructions that, when executed by the processor 51, cause the electronic device 50 to perform operations, methods or procedures set forth in the present disclosure. In some embodiments, the memory 52 may store instructions that are needed by one or more of the processor 51, the transceiver 53, and other components of the electronic device 50. The memory may further store an operating system and applications. The memory 52 may comprise, be implemented as, or be included in a read-and-write memory, a read-only memory, a volatile memory, a non-volatile memory, or a combination of some or all of the foregoing.

The antenna unit 54 includes one or more physical antennas. When MIMO or MU-MIMO is used, the antenna unit 54 may include more than one physical antenna.

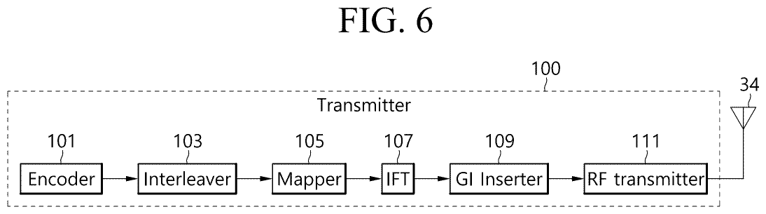

FIG. 6 illustrates a schematic diagram of an example of a transmitter in accordance with an embodiment. The transmitter in FIG. 6 may be an example of the transmitter illustrated in FIG. 5.

Referring to FIG. 6, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder. The interleaver 103 may interleave bits of encoded data from the encoder 101 to change the order of bits, and output interleaved data. In some embodiments, interleaving may be applied when BCC encoding is employed. The mapper 105 may map interleaved data into constellation points to generate a block of constellation points. If the LDPC encoding is used in the encoder 101, the mapper 105 may further perform LDPC tone mapping instead of the constellation mapping. The IFT 107 may convert the block of constellation points into a time domain block corresponding to a symbol by using an inverse discrete Fourier transform (IDFT) or an inverse fast Fourier transform (IFFT). The GI inserter 109 may prepend a GI to the symbol. The RF transmitter 111 may convert the symbols into an RF signal and transmits the RF signal via the antenna unit 34.

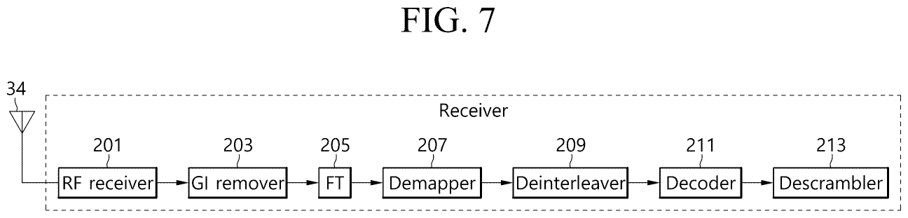

FIG. 7 illustrates a schematic diagram of an example of a receiver in accordance with an embodiment. The receiver in FIG. 7 may be an example of the receiver illustrated in FIG. 5.

Referring to FIG. 7, the receiver 200 in accordance with an embodiment may include a RF receiver 201, a GI remover 203, a Fourier transformer (FT) 205, a demapper 207, a deinterleaver 209, and a decoder 211. The RF receiver 201 may receive an RF signal via the antenna unit 34 and converts the RF signal into one or more symbols. The GI remover 203 may remove the GI from the symbol. The FT 205 may convert the symbol corresponding to a time domain block into a block of constellation points by using a discrete Fourier transform (DFT) or a fast Fourier transform (FFT) depending on implementation. The demapper 207 may demap the block of constellation points to demapped data bits. If the LDPC encoding is used, the demapper 207 may further perform LDPC tone demapping before the constellation demapping. The deinterleaver 209 may deinterleave demapped data bits to generate deinterleaved data bits. In some embodiments, deinterleaving may be applied when BCC encoding is used. The decoder 211 may decode the deinterleaved data bits to generate decoded bits. For example, the decoder 211 may be an FEC decoder. The FEC decoder may include a BCC decoder or an LDPC decoder. In order to support the HARQ procedure, the decoder 211 may combine a retransmitted data with an initial data. The descrambler 213 may descramble the descrambled data bits based on a scrambler seed.

With the popularity and growth of wireless systems, applications are being developed and commercialized that require using low latency traffic in order to provide proper functionality. These applications can include virtual reality/augmented reality (VR/AR), which ingest real-time data from different sources to provide visualizations. Other applications can include immersive gaming, remote office, and cloud-computing, among various other applications that require more challenging time-sensitive technologies. Accordingly, various technologies are being developed in order to support low latency traffic.

As introduced for in IEEE 802.11bn, for a deterministic low latency traffic, Restrict Target Wake Time (TWT) can be used to support deterministic and/or periodic low latency traffic. In particular, deterministic low latency traffic can be periodic and expected, such that an AP can schedule the traffic in advance.

However, in cases of event-based low latency traffic, which can be random and unexpected, there are no existing solutions that can support low latency traffic. Accordingly, systems and methods in accordance with many embodiments in this disclosure provide for supporting event-based low latency traffic in wireless environments.

According to existing techniques, if a primary channel is busy, a secondary channel is not used. In particular, an AP can sense, using Clear Channel Assessment (CCA), a primary channel. If the primary channel is idle, an AP can sense if a secondary channel is idle. When the secondary channel is also idle, the AP can transmit data using the first and secondary channel together using channel bonding. However, existing techniques do not provide for independently utilizing different channels, including independently sensing a secondary channel.

Accordingly, systems in accordance with many embodiments can provide utilizing one or more secondary channels independently, and even when a primary channel is busy. In particular, systems in accordance with many embodiments can perform a CCA on one or more secondary channels in order to transmit latency sensitive traffic when a primary channel is busy.

Many existing wireless systems developed according to the 802.11 standards provide transmit opportunities (TXOP) which provides contention-free channel access for a period of time. In particular, while a device (TXOP holder) acquires a transmit opportunity (TXOP) and transmits/receives data traffic with another device (TXOP responder) belonging to the same BSS, devices other than the TXOP holder and TXOP responder cannot transmit data traffic. Therefore, when a device acquires a TXOP, even if latency sensitive traffic arrives, other devices cannot immediately transmit the latency sensitive traffic during the TXOP duration. Latency sensitive traffic can only be transmitted once a TXOP is acquired through performing a procedure for channel access after the end of an existing TXOP duration. In such a situation, there can be a problem that transmission of latency sensitive traffic requiring low latency is delayed.

Accordingly, systems in accordance with many embodiments can minimize the delay of transmitting latency sensitive traffic even when there is an existing TXOP by using a secondary channel when a primary channel is busy. In particular, when a device generates latency sensitive traffic, it can transmit the latency sensitive traffic by performing a channel access procedure to acquire a TXOP if the primary channel is idle. If the primary channel is busy such as being used by another device that has acquired a TXOP and is transmitting/receiving data through the primary channel, the device that generated latency sensitive traffic can transmit the latency sensitive traffic through a secondary channel.

Accordingly, when latency sensitive traffic requiring low latency occurs from a device's upper protocol, if a primary channel among the device's operating channels is busy, a device can transmit latency sensitive traffic through an idle secondary channel as described throughout.

In order to be able to transmit latency sensitive traffic using a secondary channel while other devices are using a primary channel, a process for determining which secondary channel can be used for latency sensitive traffic transmission can be performed at an association phase between an AP and an STA in the BSS.

In many embodiments, STAs can inform an AP regarding their capabilities, including whether they have capabilities to perform clear channel assessment (CCA) for a secondary channel separately from a CCA for a primary channel. Corresponding information can be included in a latency sensitive traffic capabilities element through 1-bit signaling. This latency sensitive traffic capabilities element can be included in an association request frame.

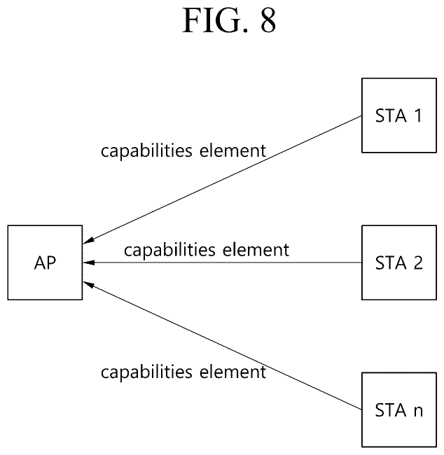

FIG. 8 illustrates several STAs (STA1, . . . , STA n) informing an AP regarding their capabilities to perform CCA in accordance with an embodiment of the present disclosure. Referring to FIG. 8, each of STAs (STA 1, . . . , STA n) may transmit a capabilities element to the AP to inform the respective STA's capabilities. The capabilities element may be included in an associate request frame. For example, the STAs may set a bit in the capabilities elements to ‘1’ if CCA for secondary channel is available, otherwise set to ‘0’. Then, upon receiving the capabilities clement regarding the latency sensitive traffic from the STAs, the AP can provide the STAs that have capabilities of performing CCA on the secondary channel with information regarding the channel for latency sensitive traffic transmission.

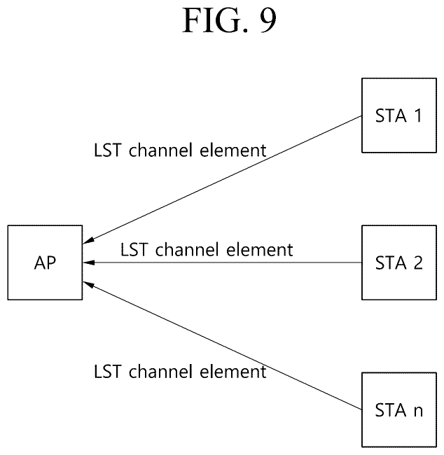

FIG. 9 illustrates an AP providing STAs (STA 1 . . . STA n) with information, which can be included in a latency sensitive traffic channel element, regarding the channel for latency sensitive traffic transmission in accordance with an embodiment of the invention. Referring to FIG. 9, the AP may transmit capabilities elements to the STAs to provide information regarding the latency sensitive traffic transmission. The capabilities elements may be included in association response frames.

Many embodiments of the system can use various explicit methods and processes, performed by an STA and/or AP, for determining a secondary channel and performing CCA on the secondary channel for latency sensitive traffic transmission including one or more of the following processes.
A. Perform CCA on all secondary channels. When the primary channel is busy, latency sensitive traffic can be transmitted through an idle channel among the secondary channels.
B. Perform CCA only on a specific secondary channel. When the primary channel is busy, latency sensitive traffic can be transmitted only through a specific secondary channel.
C. Set different secondary channels that can transmit latency sensitive traffic for each STA. If the secondary channel for latency sensitive traffic transmission is set to the same for all STAs in the BSS, there may be a problem that the traffic is overloaded on the corresponding channel. Therefore, a latency sensitive traffic channel can be determined differently for each STA.

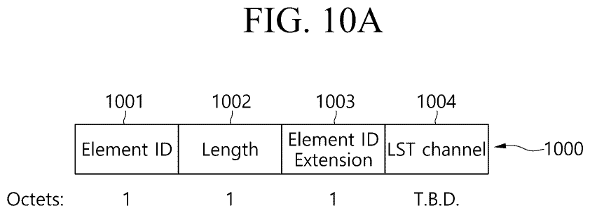

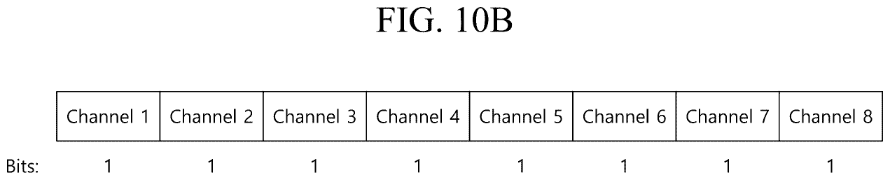

In accordance with the described processes A-C, when setting a specific secondary channel as a channel for latency sensitive traffic (e.g., a latency sensitive traffic channel), an clement can be included in an association response frame so that the AP informs STAs of the channel on which CCA is performed for latency sensitive traffic transmission. A latency sensitive traffic channel clement included in an association response frame in accordance with an embodiment is illustrated in FIG. 10A.

FIG. 10A illustrates the format of the LST channel element according to an embodiment of the present disclosure. Referring to FIG. 10A, the format of the LST channel element 1000 can include Element ID field 1001, Length field 1002, Element ID Extension field 1003, and LST Channel field 1004. The LST channel element can be identified by the Element ID field 1001 and, if present, the Element ID Extension field 1003. The Length field 1002 can indicate the number of octets in the LST channel element, for example, excluding the Element ID field 1001 and the Length field 1002. The LST (latency sensitive traffic) channel field 1004 can provide the channel on which latency sensitive traffic can be transmitted.

An example of the LST channel field in an LST channel element in accordance with an embodiment of the present disclosure is illustrated in FIG. 10B. Each ‘channel n’ subfield can represent one of the BSS operation channels, and the bandwidth of each channel be 20 MHz. Among each ‘channel n’ subfield, the channel used for latency sensitive traffic transmission can be set to ‘1’, and otherwise set to ‘0’. Here, a channel in which the value of the channel subfield is set to ‘1’ can be defined as the latency sensitive traffic channel. FIG. 10B illustrates an example of a BSS with a 160 MHz operating channel width, and there are 8 channel subfields.

If a BSS operating bandwidth is 80 MHz, the ‘channel n’ subfield in the latency sensitive traffic channel field can include channels 1, 2, 3, and 4.

If a BSS operating bandwidth is 320 MHz, the ‘channel n’ subfield in the LST channel field can include channels 1, 2, 3, 4, 5, 6, 7, 8, 9, 10, 11, 12, 13, 14, 15, and 16.

Systems in accordance with many embodiments can use an implicit method (e.g., no signaling) for determining a secondary channel used for latency sensitive traffic transmission as follows. Using an implicit method can have an advantage of reducing overhead by omitting a signaling procedure.

In many embodiments, the AP can determine a primary channel among BSS operating channels. The AP can determine the order of secondary channels to be bonded for channel bonding. In many embodiments, channel bonding can be performed in the order of the secondary channels closest to the primary channel.

In many embodiments, when the BSS operating channel bandwidth is at a particular frequency (e.g., 80 MHz), the secondary channel which the center frequency is farthest from a center frequency of the primary channel is set as the channel for latency sensitive traffic transmission among the secondary channels.

In many embodiments, when the BSS operating channel bandwidth is a particular frequency (e.g., 80 MHz), the latency sensitive traffic channel can be determined as follows according to the location of the primary channel. Each channel within the BSS operating channels has a 20 MHz bandwidth. When using channel bonding, the order in which channels are combined can be determined in the order of secondary channels close to the primary channel.

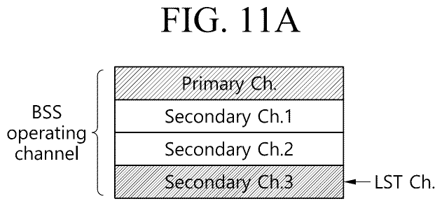

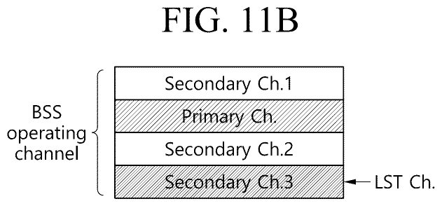

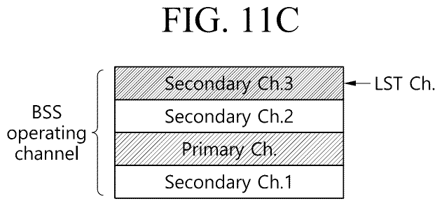

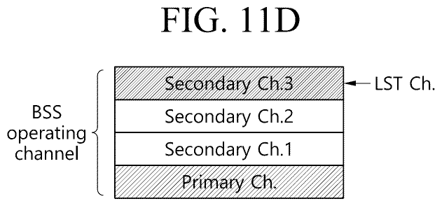

FIGS. 11A-11D illustrate channel bonding and setting a channel for latency sensitive traffic transmission in accordance with an embodiment. In particular, FIG. 11A illustrates a BSS operating channel that includes a primary channel, secondary channel 1, secondary channel 2, and secondary channel 3. In FIG. 11A, the primary channel is set to a particular channel as indicated, and the latency sensitive traffic channel is set to secondary channel 3. In many embodiments, the latency sensitive traffic channel is set to the secondary channel with a center frequency that is the farthest away from a center frequency of the primary channel. FIG. 11B-11D illustrate other configurations of the primary channel and the latency sensitive traffic channel that can be specified in accordance with the configuration of the primary channel. As illustrated in FIG. 11A-11D above, channels can be combined in the order of secondary channels 1, 2, 3. As illustrated in each of FIG. 11A-11D, the secondary channel 3, which is farthest from the primary channel, becomes the latency sensitive traffic channel.

In many embodiments, when the BSS operating channel bandwidth is 160 MHz, the latency sensitive traffic channel can be determined as follows according to the location of the primary channel. Each channel within the BSS operating channels has a 20 MHz bandwidth. When using channel bonding, the order in which channels are combined can be determined in the order of secondary channels close to the primary channel.

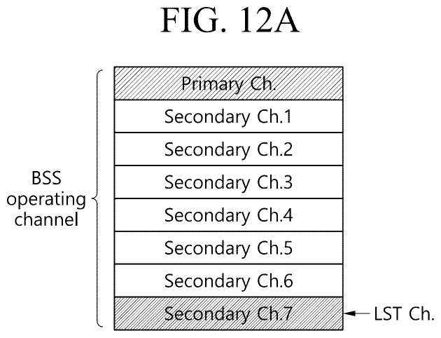

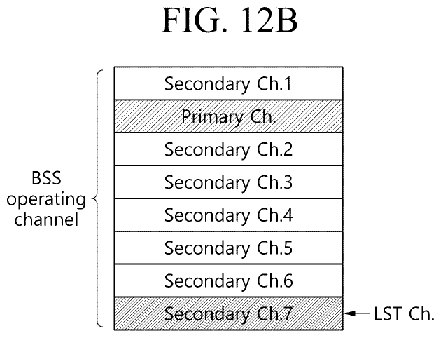

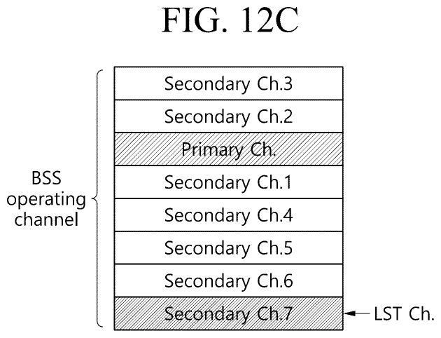

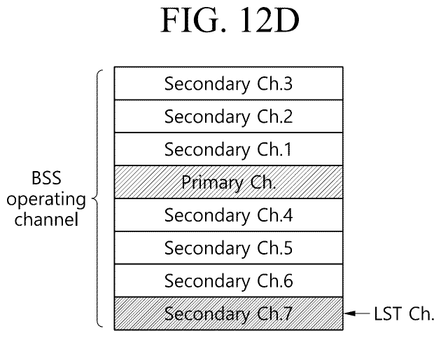

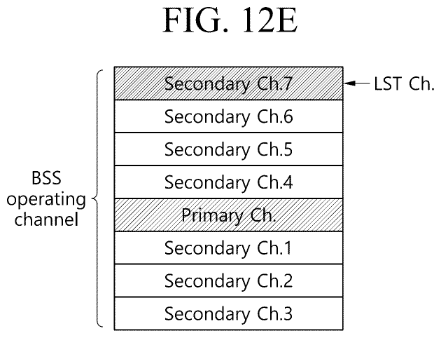

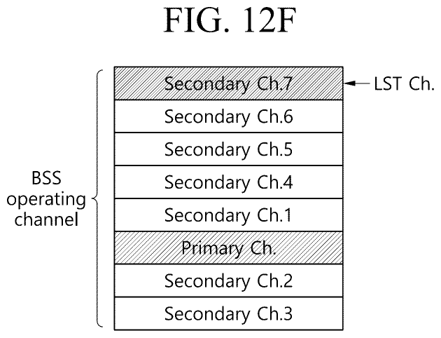

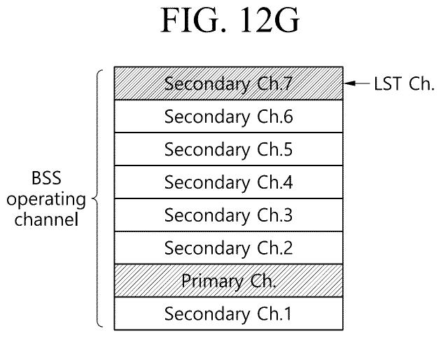

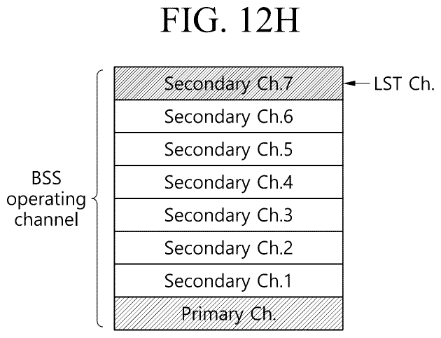

FIGS. 12A-12H illustrate channel bonding and setting of the latency sensitive traffic channel in accordance with an embodiment of the invention. In particular, FIG. 12A illustrates a BSS operating channel that includes a primary channel, and secondary channels 1 through 7. In each of FIGS. 12A-12H, an AP can determine a primary channel among the BSS operating channels, which is illustrated as a different channel in each of FIGS. 12A-12H. In FIG. 12A, the primary channel is designated at the top most channel and the latency sensitive traffic channel is set to secondary channel 7, which is designated as LST Ch in the figure. FIG. 12B-12H illustrate other configurations of the primary channel, and the corresponding location of the latency sensitive traffic channel based on the configuration of the primary channel. As illustrated in each of FIG. 12A-12H, channels can be combined in the order of secondary channels 1, 2, 3, 4, 5, 6, 7. In FIGS. 12A-12H, the secondary channel 7, which has a center frequency that is farthest from a center frequency of the primary channel, becomes the latency sensitive traffic channel. Described now are latency sensitive transmission processes in accordance with many embodiments.

In many embodiments, there can be three types of devices in BSS. A device A can be a TXOP holder, a device B can be a TXOP responder, and a device C can be neither a TXOP holder nor a TXOP responder. Process of transmitting latency sensitive traffic using latency sensitive traffic channels when latency sensitive traffic occurs for each type of device in accordance with many embodiments are described.

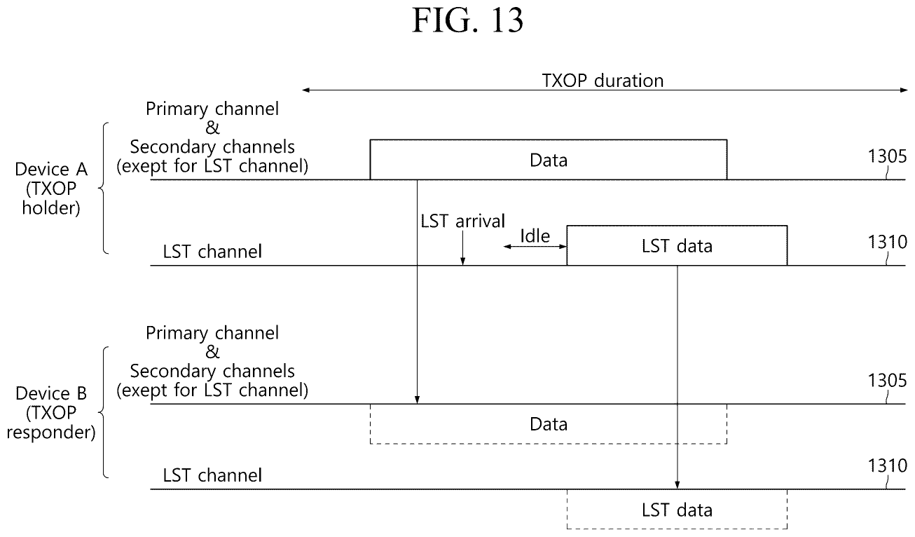

FIG. 13 illustrates a TXOP holder transmitting latency sensitive traffic on a latency sensitive traffic channel to a TXOP responder while a primary channel is busy in accordance with an embodiment. In FIG. 13, Device A is a TXOP holder, and Device B is a TXOP responder, where Device A and B can be both AP and/or STA. Device A has a primary channel and secondary channels 1305 and a latency sensitive traffic channel 1310. As explained above, the latency sensitive traffic channel 1310 may be a secondary channel among a plurality of secondary channels established between Device A and Device B. Device B is also illustrated with the primary and secondary channels 1305 and the latency sensitive traffic channel 1310.

Device A is transmitting data on the primary channel 1305 to device B. When latency sensitive traffic occurs from an upper layer of Device A while Device A is transmitting data to Device B using the primary channel, according to the existing techniques, even if Device A's secondary channel is idle, latency sensitive traffic data cannot be transmitted through the secondary channel.

However, since a specific secondary channel among BSS operating channels is designated as a latency sensitive traffic channel according to an embodiment, even if data is transmitted through the channels including primary channel 1305, latency sensitive traffic data can be transmitted through the latency sensitive traffic channel 1310 if the latency sensitive traffic channel 1310 is idle. As illustrated, when latency sensitive traffic arrives, the Device A can sense the latency sensitive traffic channel 1310. If the latency sensitive traffic channel 1310 is idle, Device A can transmit the latency sensitive traffic data to Device B. As illustrated, the latency sensitive traffic channel 1310 is idle, so Device A transmits the latency sensitive traffic data to Device B.

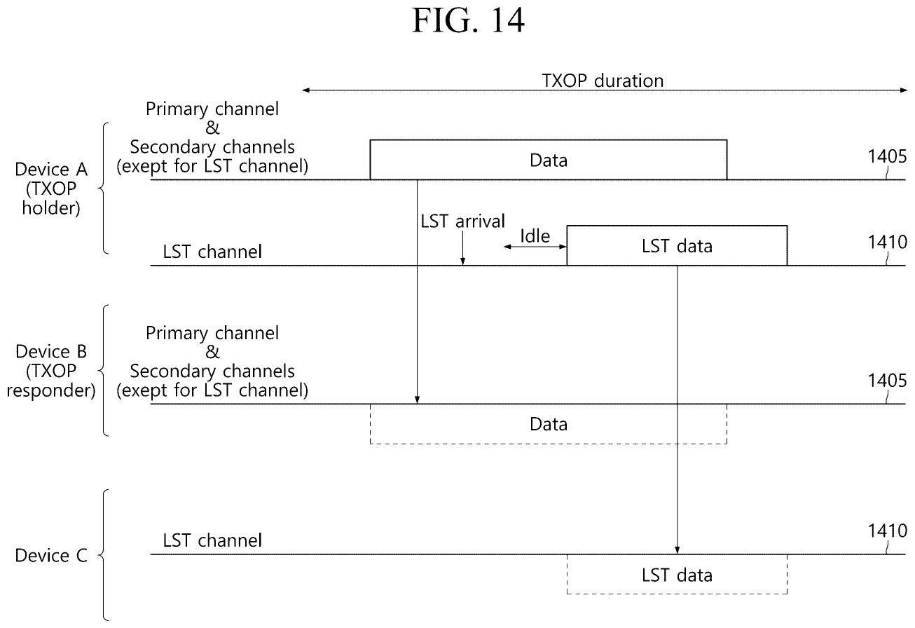

FIG. 14 illustrates transmitting latency sensitive traffic to a device that is neither a TXOP holder nor a TXOP responder on a latency sensitive traffic channel in accordance with an embodiment of the invention.

In FIG. 14, Device A has a primary channel and secondary channels 1405 and a latency sensitive traffic channel 1410. As explained above, the latency sensitive traffic channel 1410 may be a secondary channel among a plurality of secondary channels established between Device A and Device C. Device B is also illustrated with the primary and secondary channels 1405 and Device C is illustrated with the latency sensitive traffic channel 1410. In FIG. 14, Device A is a TXOP holder, Device B is a TXOP responder, and Device C is neither a TXOP holder nor a TXOP responder. As illustrated, latency sensitive traffic occurs from an upper layer of Device A while Device A is transmitting data to Device B through the channels including primary channel 1405. The latency sensitive traffic is data that Device A may transmit to Device C. Since the Device A established a latency sensitive traffic channel 1410 at the association phase with the Device C, when latency sensitive traffic occurs, latency sensitive traffic data can be transmitted through the latency sensitive traffic channel 1410 if the latency sensitive traffic channel is idle. Therefore, as illustrated, latency sensitive traffic to be transmitted by Device A to Device C occurs, the latency sensitive traffic data can be transmitted through the latency sensitive traffic channel 1410 as this channel was idle.

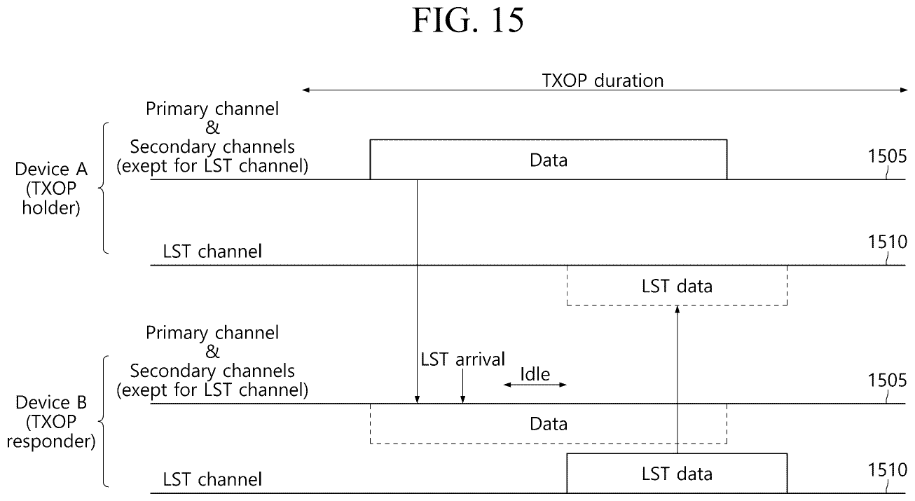

FIG. 15 illustrates transmitting latency sensitive traffic from a TXOP responder to a TXOP holder on a latency sensitive traffic channel when a primary channel is busy in accordance with an embodiment of the invention. As illustrated, Device A is a TXOP holder, and Device B is a TXOP responder (where Device A and B can be both AP and/or STA).

In FIG. 15, Device A has a primary channel and secondary channels 1505 and a latency sensitive traffic channel 1510. As explained above, the latency sensitive traffic channel 1510 may be a secondary channel among a plurality of secondary channels established between Device A and Device B. Device B is also illustrated with the primary and secondary channels 1505 and the latency sensitive traffic channel 1510. An AP can establish a latency sensitive traffic channel 1510 at the association phase with the STAs and then the AP and STAs can perform a channel access procedure on the latency sensitive traffic channel 1510. As illustrated in FIG. 15, when latency sensitive traffic occurred from the upper layer of Device B while Device A is transmitting data to Device B through the channels including the primary channel 1505, latency sensitive traffic data from Device B can be transmitted through the latency sensitive traffic channel 1510 to Device A if the latency sensitive traffic channel is idle. As illustrated, Device B is transmitting latency sensitive traffic to Device A on the latency sensitive traffic channel 1510 while Device A is transmitting data to Device B on the primary channel 1505.

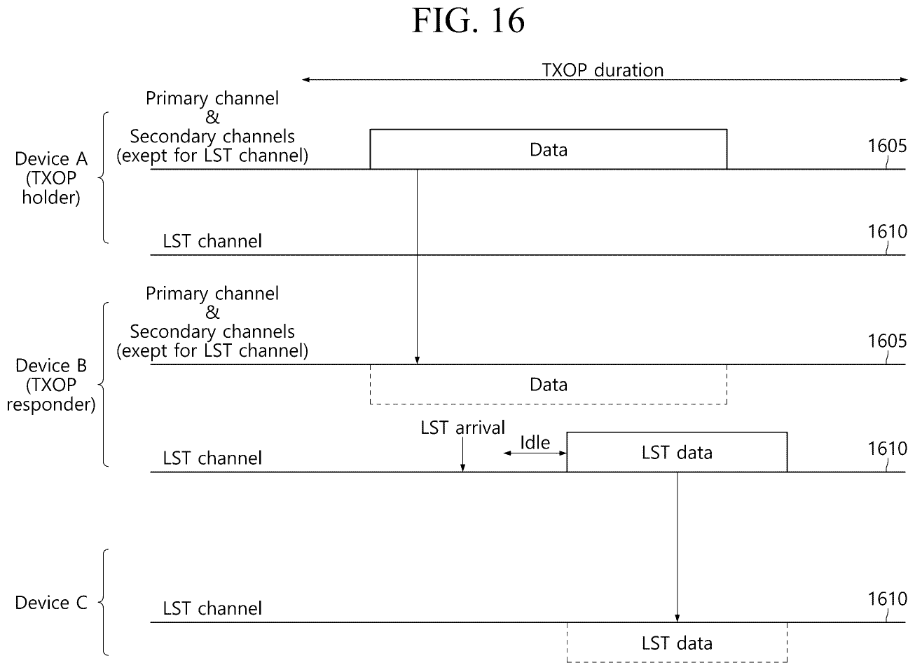

FIG. 16 illustrates a TXOP holder transmitting data to a TXOP responder on a primary channel and the TXOP responder transmitting latency sensitive traffic data to a device that is neither a TXOP holder nor a TXOP responder on a latency sensitive traffic channel in accordance with an embodiment of the invention. In FIG. 16, Device A is a TXOP holder, Device B is a TXOP responder, and Device C is neither TXOP holder nor TXOP responder.

In FIG. 16, Device A has a primary channel and secondary channels 1605 and a latency sensitive traffic channel 1610. As explained above, the latency sensitive traffic channel 1610 may be a secondary channel among a plurality of secondary channels established between Device A, Device B and Device C. Device B is also illustrated with the primary and secondary channels 1605 and the latency sensitive traffic channel 1610. Device C is illustrated with latency sensitive traffic channel 1610. An AP can establish a latency sensitive traffic channel 1610 at the association phase with the STAs and then the AP and STAs can perform a channel access procedure on the latency sensitive traffic channel 1610.

As illustrated, latency sensitive traffic occurs from the upper layer of Device B while Device A is transmitting data to Device B through the channels including primary channel and secondary channels 1605. The latency sensitive traffic is data that Device B should transmit to Device C. Since Device B established a latency sensitive traffic channel 1610 at the association phase with the Device C, when latency sensitive traffic occurs, latency sensitive traffic data can be transmitted through the latency sensitive traffic channel 1610 if the latency sensitive traffic channel is idle. Therefore, as illustrated, latency sensitive traffic to be transmitted by Device B to Device C occurs, the latency sensitive traffic data is transmitted through the latency sensitive traffic channel 1610 as this channel was idle.

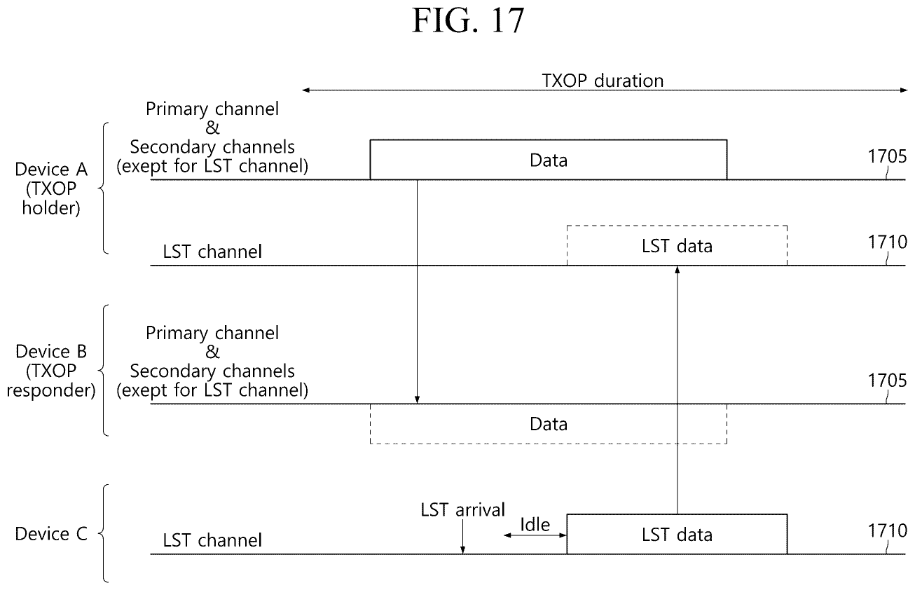

FIG. 17 illustrates transmitting latency sensitive traffic data from a device that is neither a TXOP holder nor a TXOP responder to a TXOP holder on a latency sensitive traffic channel when a primary channel is busy in accordance with an embodiment of the invention. As illustrated in FIG. 17, Device A is a TXOP holder, Device B is a TXOP responder, and Device C is neither TXOP holder nor TXOP responder.

In FIG. 17, Device A has a primary channel and secondary channels 1705 and a latency sensitive traffic channel 1710. As explained above, the latency sensitive traffic channel 1710 may be a secondary channel among a plurality of secondary channels established between Device A and Device C. Device B is also illustrated with the primary and secondary channels 1705 and Device C is illustrated with latency sensitive traffic channel 1710. An AP can establish the latency sensitive traffic channel 1710 at the association phase with the STAs and then the AP and STAs can perform a channel access procedure on the latency sensitive traffic channel 1710.

Latency sensitive traffic occurs from the upper layer of Device C while Device A is transmitting data to Device B through the channels including primary channel and secondary channels 1705. The latency sensitive traffic is data that Device C should transmit to Device A. Since the AP established a latency sensitive traffic channel 1710 at the association phase with the STA, when latency sensitive traffic occurs, latency sensitive traffic data can be transmitted through the latency sensitive traffic channel 1710 if the latency sensitive traffic channel is idle. As illustrated in FIG. 17, latency sensitive traffic to be transmitted by Device C to Device A occurs, the latency sensitive traffic data is transmitted through the latency sensitive traffic channel 1710 as the primary channel 1705 is busy.

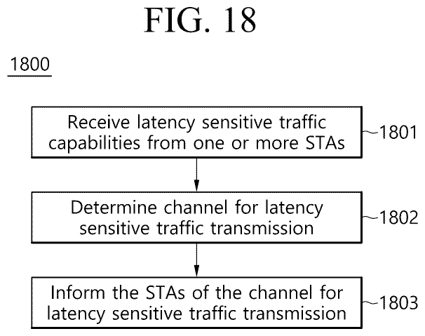

FIG. 18 illustrates a flow chart of an example of determining a latency sensitive traffic channel between an AP and one or more STAs in accordance with an embodiment. For explanatory and illustration purpose, the example process 1800 may be performed by an AP and/or one or more STAs. The blocks of the example process 1800 are described herein as occurring in serial or linearly. However, multiple blocks of the example process 1800 may occur in parallel. In addition, the blocks of the example process 1800 need not be performed in the order shown and/or one or more of the blocks/actions of the example process 1800 need not be performed.

At S1801, an AP may receive information regarding CCA capabilities from one or more STAs. In many embodiments, the STAs can inform the AP whether they have capabilities to perform CCA for a secondary channel separately from the CCA of a primary channel. The corresponding information can be included in an LST capabilities element, for example, through 1-bit signaling, and the LST capabilities element can be included in an association request frame.

At S1802, the AP may determine a channel for latency sensitive traffic transmission. In many embodiments, the AP can use one of an explicit method and/or an implicit method for determining a latency sensitive traffic channel. The explicit method can include performing CCA on all secondary channels and, when a primary channel is busy, latency sensitive traffic can be transmitted through an idle channel among the secondary channels. In many embodiments, CCA can be performed only on a specific secondary channel, in particular, when the primary channel is busy, latency sensitive traffic is transmitted only though a specific secondary channel. In many embodiments, a different secondary channel that can transmit latency sensitive traffic can be set for each STA. Accordingly, latency sensitive traffic channel can be determined differently for each STA.

An implicit method for determining a secondary channel for latency sensitive traffic transmission can include determining a primary channel among BSS operating channels, determining the order to channels to be bonded for channel bonding, where the channel bonding can be performed in the order of the secondary channels closest to the primary channel, and setting the secondary channel which the center frequency is farthest from a center frequency of the primary channel as the channel for latency sensitive traffic transmission among the secondary channels.

At S1803, the AP may inform the one or more STAs of the channel for the latency sensitive traffic. In many embodiments, when the latency sensitive traffic channel is set, the AP can inform the STAs using a LST channel element that can be included in an association response frame.

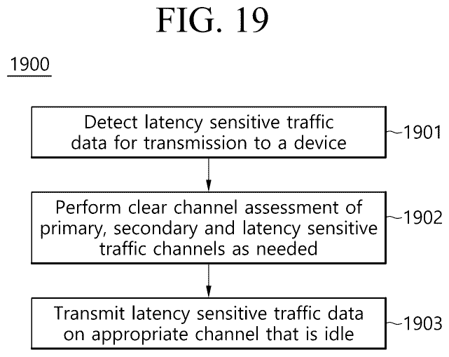

FIG. 19 illustrates a flow chart of an example of transmitting latency sensitive traffic between devices in accordance with an embodiment. For explanatory and illustration purpose, the example process 1900 may be performed by an AP and/or STA. The blocks of the example process 1900 are described herein as occurring in serial or linearly. However, multiple blocks of the example process 1900 may occur in parallel. In addition, the blocks of the example process 1900 need not be performed in the order shown and/or one or more of the blocks/actions of the example process 1900 need not be performed.

At S1901, a device A can detect latency sensitive traffic data for transmission to a different device B. The device A can a TXOP holder, a TXOP responder or neither a TXOP holder nor a TXOP responder.

At S1902, device A can perform a CCA on a primary channel, a secondary channel, and/or a latency sensitive traffic channel.

At S1903, device A can transmit latency sensitive traffic data on an appropriate channel that is idle. In particular, if the primary channel and/or secondary channels are idle, device A can transmit the latency sensitive traffic to Device B on the primary/secondary channels. If the primary/secondary channels are busy, Device A can perform CCA on the latency sensitive traffic channel, and if this is idle, Device A can transmit the latency sensitive traffic data to Device B on the latency sensitive traffic channel, otherwise, if the latency sensitive traffic channel is busy, Device B can wait a certain time period to repeat the CCA process.

To illustrate the interchangeability of hardware and software, items such as the various illustrative blocks, modules, components, methods, operations, instructions, and algorithms have been described generally in terms of their functionality. Whether such functionality is implemented as hardware or software depends upon the particular application and design constraints imposed on the overall system. Skilled artisans may implement the described functionality in varying ways for each particular application.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station device for connecting to a wireless network, comprising processing circuitry configured to:
transmit capabilities information regarding an ability to perform clear channel assessment (CCA) on one or more secondary channels of a basic service set (BSS) to an access point (AP) device;
receive channel information identifying a primary channel and a secondary channel that is used for latency sensitive data from the AP device;
detect an occurrence of latency sensitive data to be transmitted to a first device;
perform CCA on the primary channel and detect that the primary channel is busy;
perform CCA on the secondary channel that is used for latency sensitive data and detect that the secondary channel is idle; and
transmit the latency sensitive data on the secondary channel to the first device.

2. The station device of claim 1, wherein the processing circuitry is configured to:
transmit or receive data on the primary channel with the first device.

3. The station device of claim 1, wherein the processing circuitry is configured to:
transmit or receive data on the primary channel with a second device that is different from the first device.

4. The station device of claim 1, wherein the station device is a transmission opportunity (TXOP) holder or a TXOP responder.

5. The station device of claim 4, wherein the latency sensitive data is transmitted to the first device during a TXOP duration of the station device.

6. The station device of claim 1, wherein the first device is the AP device.

7. The station device of claim 1, wherein the secondary channel that is used for latency sensitive data has a center frequency that is farthest from a center frequency of the primary channel among a plurality of secondary channels in a basic service set (BSS).

8. The station device of claim 1, wherein the processing circuitry is configured to:
receive information explicitly identifying the secondary channel that is used for latency sensitive data.

9. The station device of claim 1, wherein the processing circuitry is further configured to:
perform CCA on a plurality of secondary channels; and
transmit latency sensitive data through an idle channel among the plurality of secondary channels.

10. A station device for connecting to a wireless network, comprising processing circuitry configured to:
transmit capabilities information regarding an ability to perform clear channel assessment (CCA) on one or more secondary channels of a basic service set (BSS) to an access point (AP) device;
receive channel information identifying a primary channel and a secondary channel that is used for latency sensitive data from the AP device;
transmit or receive data on the primary channel with a first device; and
receive latency sensitive data on the secondary channel that is used for latency sensitive data from a second device.

11. The station device of claim 10, wherein the station device is a transmission opportunity (TXOP) holder or a TXOP responder.

12. The station device of claim 10, wherein the first device is same as the second device.

13. The station device of claim 10, wherein the secondary channel used for latency sensitive data has a center frequency that is farthest from a center frequency of the primary channel among a plurality of secondary channels in a basic service set (BSS).

14. The station device of claim 10, wherein the processing circuitry is configured to:
receive information explicitly identifying the secondary channel that is used for latency sensitive data.

15. The station device of claim 10, wherein the processing circuitry is further configured to:
perform CCA on a plurality of secondary channels; and
transmit latency sensitive data through an idle channel among the plurality of secondary channels.

16. An access point (AP) device for facilitating wireless communication in a wireless network, the AP device comprising processing circuitry configured to:
receive capabilities information regarding an ability to perform clear channel assessment (CCA) on one or more secondary channels of a basic service set (BSS) from a first station (STA) device;
generate channel information for the first STA device identifying a primary channel and a secondary channel that is used for latency sensitive data; and
provide the channel information to the first STA device.

17. The AP device of claim 16, wherein the secondary channel used for latency sensitive data has a center frequency that is farthest from a center frequency of the primary channel among a plurality of channels in a basic service set (BSS).

18. The AP device of claim 16, wherein the processing circuitry is further configured to:
receive capabilities information regarding an ability to perform clear channel assessment (CCA) on one or more secondary channels of a basic service set (BSS) from a second STA device;
generate channel information for the second STA identifying a primary channel and a secondary channel that is used for latency sensitive data; and
provide the channel information to the second STA device, wherein the secondary channel that is used for latency sensitive data for the second STA device is different from the secondary channel that is used for latency sensitive data for the first STA device.

19. The AP device of claim 16, wherein the processing circuitry is further configured to:
set the secondary channel that is farthest from the primary channel as the secondary channel that is used to for latency sensitive data for the first STA.

20. The AP device of claim 16, wherein the processing circuitry is configured to:
transmit information explicitly identifying the secondary channel that is used for latency sensitive data to the first STA device.
